(19) United States
(12) Patent Application Publication
(10) Pub. No.: US 2024/0140277 A1
(43) Pub. Date: May 2, 2024

(54) VEHICLE SEAT BACKREST

(71) Applicant: FAURECIA Sièges d'Automobile, NANTERRE (FR)

(72) Inventors: Jean-Marc JUDIC, SAINT REMY LES (FR); Frédéric MAZZAMURRO, SAINT JEAN DE BRAYE (FR); Fabrice CAMUS, BRÉTIGNY SUR ORGE (FR)

(21) Appl. No.: 18/383,936

(22) Filed: Oct. 26, 2023

(30) Foreign Application Priority Data
Oct. 27, 2022 (FR) 2211224

(51) Int. Cl. B60N 2/22

(52) U.S. Cl. CPC B60N 2/2231; B60N 2/2222

(57) ABSTRACT

The present disclosure relates to a backrest for a vehicle seat comprising a backrest frame and a upper backrest adjustment device comprising a support member intended to receive, bearing against a front face, the upper back of an occupant of the seat, pivotably mounted on the backrest frame; at least one first connecting rod pivotably articulated relative to the backrest frame; an intermediate part between the support member and the first connecting rod, pivotably articulated relative to the support member and relative to the first connecting rod, an actuator for adjusting the position of the support member between a retracted position and an advanced position, the actuator comprising a pivotably articulated connecting part relative to the intermediate part.

### PRIORITY CLAIM

This application claims priority to French Patent Application No. FR2211224, filed Oct. 27, 2022, which is expressly incorporated by reference herein.

### BACKGROUND

The present disclosure relates a vehicle seat backrest. The present description also relates to a vehicle seat comprising such a backrest.

### SUMMARY

According to the present disclosure, a backrest for a vehicle seat comprises a backrest frame and an upper backrest adjustment device. The upper backrest adjustment device comprising:
a support member comprising a body intended to receive, bearing against a front face, the upper back of an occupant of the seat, the support member being pivotably mounted about a first transverse axis on the backrest frame;
at least one first connecting rod pivotably articulated relative to the backrest frame about a second transverse axis;
an intermediate part between the support member and the first connecting rod, the intermediate part being pivotably articulated relative to the support member about a third transverse axis and relative to the first connecting rod about a fourth transverse axis,
an actuator for adjusting the position of the support member about the first transverse axis between a retracted position and an advanced position, the actuator comprising a connecting part pivotably articulated relative to the intermediate part about a fifth transverse axis, the actuator being adapted to move the connecting part in translation along a first axis perpendicular to the transverse direction.

In illustrative embodiments, the upper backrest adjustment device has a kinematic that reduces the variation in the force required by the actuator during the forward rotation of the support member about the first transverse axis between the retracted position and the advanced position (that is, from the retracted position to the advanced position). In particular, the observed maximum relative variation of the force required by the actuator to rotate the support member about the first transverse axis is less than 20%.

In illustrative embodiments, the kinematics of the upper backrest adjustment device allows a reduction in the force required by the actuator to drive the support member forward about the first transverse axis when the latter is in the vicinity of the retracted position relative to comparative upper backrest adjustment devices. Thus, the motor may have reduced dimensions allowing it to be integrated into the backrest while limiting, or even avoiding, the subjecting of the latter to excessive loading. This makes it possible to preserve the motor from premature wear and to keep the upper backrest adjustment device compact.

In illustrative embodiments, the kinematics of the upper backrest adjustment device allows a reduction in the maximum force transmitted to the kinematics and to the actuator during a collision. In particular, an approximately 40% reduction of the force transmitted to the kinematics and to the actuator during a collision was measured when the support member is in the retracted position. The kinematics of the upper backrest adjustment device also make it possible to reduce the relative variation of the force transmitted to the actuator during a collision over the angular range of rotation of the support member about the first transverse axis.

In illustrative embodiments, the backrest frame may comprise a first upright and a second upright. The backrest frame may comprise at least one cross-member that extends transversely between the first upright and the second upright. The cross-member may be connected on each side in the transverse direction respectively to the first upright and to the second upright.

In illustrative embodiments, the body of the support member may be intended to be in contact, optionally by means of a lining and/or a cover at least partially covering the body of the support member, with the upper back of the occupant of the seat, in particular with the occupant's shoulders and/or shoulder blades. The body may have a front face, intended to be oriented toward the upper back of an occupant of the seat. The front face may be flat or concave. The body may also comprise a rear face opposite the front face. The rear face may comprise reinforcing ribs. The reinforcing ribs here form cavities. The rotation of the support member about the first transverse axis between a retracted position and an advanced position may correspond to a 15° rotation of the support member about the first transverse axis.

In illustrative embodiments, the support member and the uprights of the backrest frame may comprise associated reliefs, in particular by matching shapes, to guide the support member in rotation about the first transverse axis, relative to the first upright and second upright of the backrest frame. The reliefs of the support member can be transversely protruding from the body of the support member, the reliefs of the support member preferably extending from lateral faces of the body of the support member, the reliefs of the support member each being received respectively in a recess of the first upright and a recess of the second upright of the backrest frame.

In illustrative embodiments, the actuator may comprise a motor and a worm extending along the first axis perpendicular to the transverse direction, the connecting part being rigidly connected to one end of the worm, the motor being adapted to move the worm in translation along the direction of the first axis perpendicular to the transverse direction.

In illustrative embodiments, the upper backrest adjustment device comprising such an actuator allows a linearity between the translation of the worm in the direction of the first axis perpendicular to the transverse direction and the rotation of the support member about the first transverse axis. The adjustment of the position of the support member about the first transverse axis is thus easier and more comfortable for an occupant seated on the seat. The motor can move the worm in translation along the first axis perpendicular to the transverse axis by means of a gear.

In illustrative embodiments, the motor and the worm can be pivotably articulated relative to the support member about a sixth transverse axis. This reduces the isostatism stresses of the upper backrest adjustment device. Thus, the upper backrest adjustment device is advantageously isostatic, which facilitates assembly thereof and reduces, or eliminates, the risk of the worm flexing in the event of a collision of the vehicle. The angular displacement about the sixth transverse axis of the motor and the worm relative to the support member may be less than or equal to 4°.

In illustrative embodiments, the second transverse axis, the fourth transverse axis and the fifth transverse axis may be substantially aligned when the support member is in the advanced position or in the vicinity of the advanced position. Thus, when an occupant has their upper back resting on the body of the support member, the force induced on the support member is transmitted to the first connecting rod and then to the backrest frame instead of being transmitted to the actuator, which protects the actuator from premature wear.

In illustrative embodiments, the upper backrest adjustment device may comprise a second connecting rod pivotably articulated relative to the backrest frame about the second transverse axis. The intermediate part may comprise a first flange and a second flange separated from each other in the transverse direction, the first flange being pivotably articulated relative to the first connecting rod about the fourth transverse axis and the second flange being pivotably articulated to the second connecting rod about the fourth transverse axis. The arrangement of two connecting rods makes it possible to reinforce the structure of the upper backrest adjustment device in case of vehicle collision, in particular by making it possible to prevent the upper backrest adjustment device from twisting.

In illustrative embodiments, the intermediate part may comprise a side member that extends transversely and connects the first flange and the second flange together. The side member makes it possible to maintain the spacing in the transverse direction between the first flange and the second flange.

In illustrative embodiments, the first connecting rod and the second connecting rod may each comprise a first end and a second end. The first connecting rod and the second connecting rod may each be pivotably articulated to the backrest frame at their first end. In particular, the first connecting rod and the second connecting rod may each be pivotably articulated relative to a respective branch of a U-shaped guide which is rigidly connected with the cross-member.

In illustrative embodiments, the first connecting rod and the second connecting rod can each be respectively pivotably articulated relative to the first flange and to the second flange at their second end. To this end, the first flange and the second flange may each comprise a first hole centered on the fourth transverse axis and through which a pivot member extends.

In illustrative embodiments, the first flange and the second flange can each extend perpendicularly to the transverse direction, the first flange and the second flange each having a substantially triangular shape whose apices are respectively in the vicinity of the third transverse axis, the fourth transverse axis and the fifth transverse axis.

In illustrative embodiments, the upper backrest adjustment device may comprise a first shaft extending along the third transverse axis, the first shaft being rigidly connected to the support member, the intermediate part being pivotably mounted on the first shaft.

In illustrative embodiments, the first flange and the second flange can each comprise a second hole centered on the third transverse axis and through which the first shaft extends.

In illustrative embodiments, the support member may comprise a first tab and a second tab each extending from the rear face of the body. The first shaft can extend transversely from the first leg to the second leg. The first shaft may comprise a first retention part relative to the support member in a first direction of the third transverse axis and a second retention part relative to the support member in a second direction of the third transverse axis, the second direction being opposite to the first direction. The first retention part and the second retention part may bear in the direction of the third transverse axis respectively on a face of the first tab and a face of the second tab that are opposite each other in the direction of the third transverse axis.

In illustrative embodiments, the first tab and the second tab can each comprise a hole centered on the third transverse axis, through which the first shaft extends. The second retention part can be resiliently deformable so as to be able to be inserted into the hole of each of the tabs and the second hole of each flange, and to cooperate by resilient return with the bearing face of the second tab.

In illustrative embodiments, the upper backrest adjustment device may comprise a second shaft extending along the fifth transverse axis, the second shaft being rigidly connected to the intermediate part, the linking part being pivotably mounted on the second shaft.

In illustrative embodiments, the first flange and the second flange can each comprise a third hole centered on the fifth transverse axis and through which the second shaft extends.

In illustrative embodiments, the second shaft may comprise a first retention part relative to the intermediate part in a first direction of the fifth transverse axis and a second retention part relative to the intermediate member in a second direction of the third transverse axis, the second direction being opposite to the first direction. The first retention part and the second retention part may bear in the direction of the fifth transverse axis respectively on a face of the first flange and a face of the second flange that are opposite each other in the direction of the fifth transverse axis. The second retention part can be resiliently deformable so as to be able to be inserted into the third hole of each flange, and to cooperate by resilient return with the bearing face of the second flange.

In illustrative embodiments, the connecting part may comprise a tubular part through which the second shaft extends free to rotate about the fifth transverse axis.

The body of the support member can form, at a rear face, an indentation wherein the intermediate part is entirely or partially received, the at least one first connecting rod and the actuator. The upper backrest adjustment device advantageously has a small form factor.

In illustrative embodiments, a vehicle seat is proposed comprising a squab with a squab frame, and a backrest as described above, the backrest frame being attached to the squab frame, the backrest frame being preferably pivotably mounted about a seventh transverse axis relative to the squab frame.

In illustrative embodiments, the vehicle seat may comprise a headrest. The body of the support member may be adapted to receive pins from the headrest, preferably so as to be able to adjust the height position relative to the support member.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 schematically shows a comparative backrest for a vehicle seat comprising a upper backrest adjustment device;

FIG. 2 comprises FIGS. 2a and 2b which schematically show the kinematics of the upper backrest adjustment device of the backrest of FIG. 1, respectively in a retracted position and an advanced position;

FIG. 3 schematically shows a side view of a vehicle seat according to the present disclosure;

FIG. 4 comprises FIGS. 4a and 4b which show a partial sectional view of a backrest of the seat of FIG. 3, with an upper backrest adjustment device in a retracted position in FIG. 4a and in an advanced position in FIG. 4b;

FIG. 5 shows a partial rear view of the backrest of FIG. 4 wherein the cross-member has been removed;

FIG. 6 shows a partial perspective view of the backrest of FIG. 4 wherein the cross-member has been removed and wherein the upper backrest adjustment device is in the retracted position;

FIG. 7 shows a partial perspective view of the backrest of FIG. 4 wherein the cross-member has been removed and wherein the upper backrest adjustment device is in the advanced position;

FIG. 8 comprises FIGS. 8a to 8c which respectively represent an intermediate part, a first shaft and a second shaft connected to a connecting part, each belonging to the upper backrest adjustment device of the backrest of FIG. 4; and

FIG. 9a is a graph comparing the comparative upper backrest adjustment device (called the comparative UBA) and according to the present description (called the UBA according to the present description) in terms of actuator force;

FIG. 9b is a graph comparing the comparative upper backrest adjustment devices and according to the present description in terms of kinematic parameters; and

FIG. 9c is a graph comparing the comparative upper backrest adjustment devices and according to the present description with respect to resistance following a collision.

### DETAILED DESCRIPTION

In the following description, when referring to terms qualifying absolute position, such as the terms “front”, “rear”, “top”, “bottom”, “left”, “right”, etc., or relative ones, such as the terms “above”, “below”, “upper”, “lower”, etc., or to qualifiers of orientation, such as “horizontal”, “vertical”, etc., reference is made, unless otherwise specified, to the orientation of the figures or a seat in its normal position of use.

In the following, the longitudinal direction X means the longitudinal direction of the seat. The longitudinal direction X of the seat is considered to be the same as the longitudinal direction of the motor vehicle wherein the seat is mounted. This longitudinal direction X corresponds to the normal direction in which the vehicle advances. The longitudinal direction X is preferably horizontal. The transverse direction Y is the transverse direction of the seat. The transverse direction of the seat thus corresponds to the transverse or lateral direction of the motor vehicle. This transverse direction corresponds to a direction perpendicular to the normal direction of travel of the vehicle. The transverse direction Y is preferably horizontal. Finally, the vertical direction Z is a vertical direction of the seat, perpendicular to the longitudinal X and transverse Y directions.

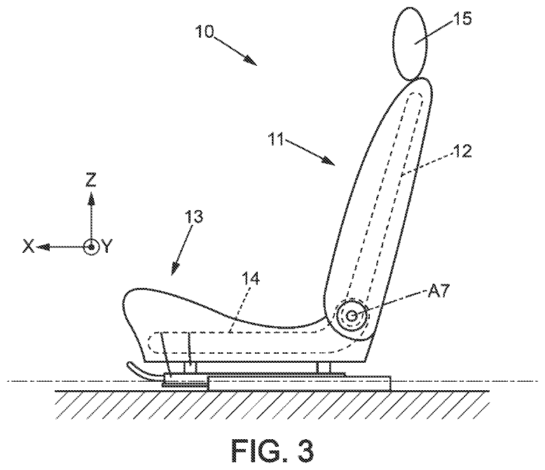

FIG. 3 schematically shows a motor vehicle seat 10. Here, it is mounted on a slide mechanism making it possible to slide the seat 10 in the longitudinal direction X.

The seat 10 comprises a squab 13 with a squab frame 14. The seat 10 also comprises a backrest 11 with a backrest frame 12. The backrest frame 12 is mounted on the squab frame 14, pivoting about a transverse articulation axis A7 (also called seventh transverse axis A7 in the present description with reference to the other transverse axes described below), by at least one suitable articulation mechanism. The seat 10 further comprises a headrest 15.

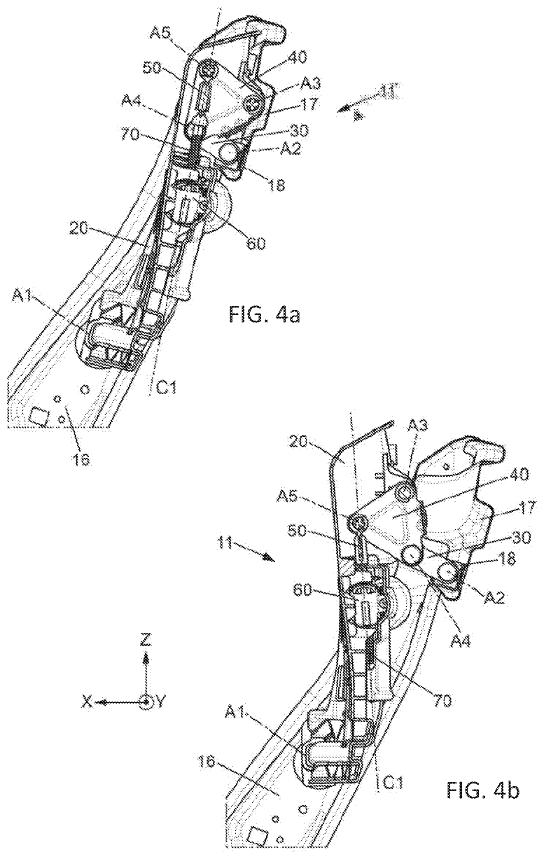

In the following, the seat 10 backrest 11 is described in more detail with reference to FIGS. 4 to 9. Here the backrest 11 comprises a upper backrest adjustment device (commonly called a UBA for short).

The backrest frame 12 comprises a first upright 16 and a second upright 16′. In the example shown, the backrest frame 12 further comprises a cross-member 17. Here the cross-member 17 is an upper cross-member 17. Indeed, the cross-member 17 is attached to upper end portions of the first upright 16 and the second upright 16′ of the backrest frame 12. The upper ends of the first upright 16 and the second upright 16′ are for example the ends of the first and second uprights 16, 16′, opposite to their respective ends, intended to receive an articulation mechanism.

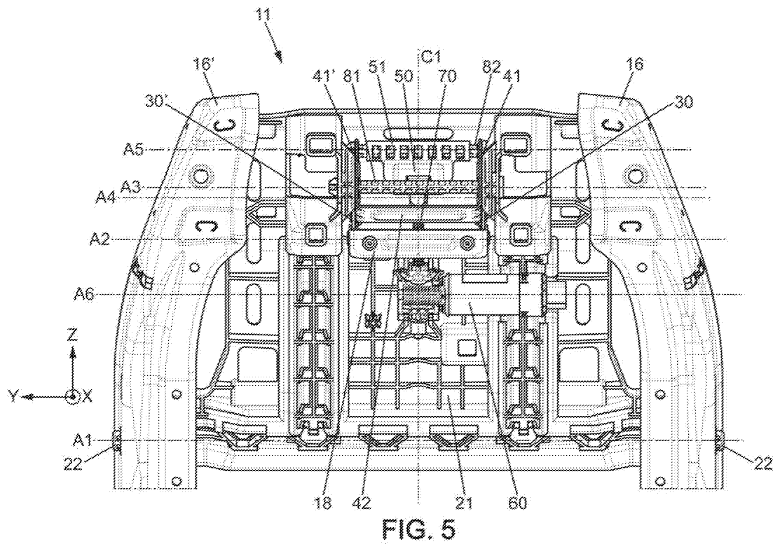

The upper backrest adjustment device firstly comprises a support member 20. The support member 20 comprises a body 21 intended to receive, bearing against a front face, the upper back of an occupant of the seat 10, in particular with the occupant's shoulders and/or shoulder blades. The body 21 of the support member 20 can be intended to be in contact, optionally by means of a lining and/or a cover at least partially covering same. The body 21 has a front face, intended to be oriented in the direction of the upper back of an occupant of the seat 10. The front face may be flat or concave. The body 21 further comprises a rear face opposite the front face. The rear face here comprises reinforcing ribs visible in FIGS. 5 to 7, which forming cavities. The body 21 of the support member 20 is located opposite in the longitudinal direction X and in front of the cross-member 17. Finally, the body 21 of the support member 20 may be adapted to receive pins from the headrest 15, preferably so as to be able to adjust the height position relative to the support member 20.

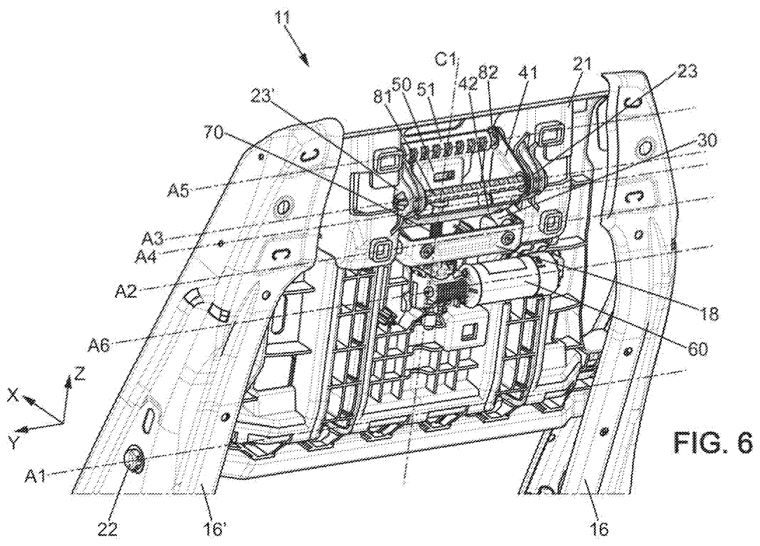

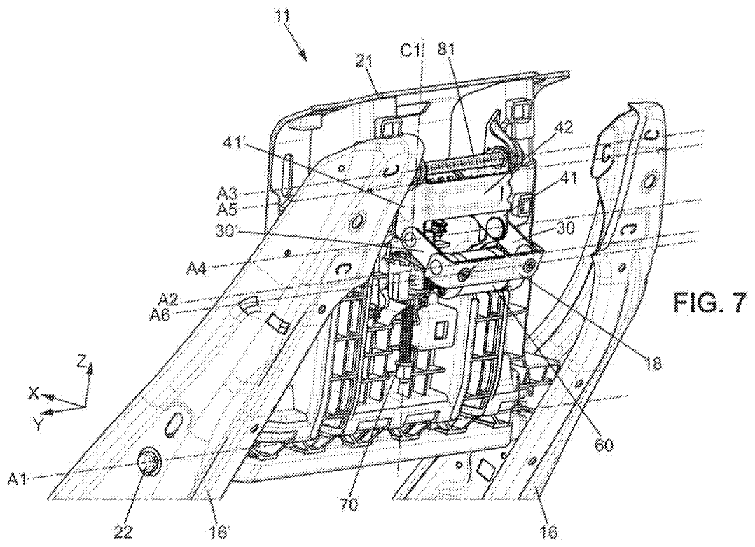

The support member 20 is pivotably mounted about a first transverse axis A1 on the backrest frame 12. In particular, the support member 20 is movable about the first transverse axis A1 between a retracted position shown in FIGS. 4a and 6 and an advanced position shown in FIGS. 4b and 7. The rotation of the support member 20 about the first transverse axis A1 between the retracted position and an advanced position may correspond to a rotation of the support member 20 about the first transverse axis A1 by an angle θmax equal to 15°. The support member 20 is moved into the advanced position after a forward rotation from the retracted position. In other words, the support member 20 is moved further away from the cross-member 17 in the advanced position than in the retracted position. The advanced position can provide support between the upper back of an occupant of the seat 10 and the support member 20, thus improving the occupant's comfort.

To allow the rotation of the support member 20 about the first transverse axis A1, the support member 20 and the uprights 16, 16′ of the backrest frame 12 may comprise associated reliefs, in particular by matching shapes, to guide 18 the support member 20 in rotation about the first transverse axis A1, relative to the first upright 16 and second upright 16′ of the backrest frame 12. Here, the reliefs 22 of the support member 20 are transversely protruding from the body 21 of the support member 20. The reliefs 22 of the support member 20 extend from lateral faces of the body 21 of the support member 20 and are each received respectively in a recess of the first upright 16 and a recess of the second upright 16′ of the backrest frame 12.

The upper backrest adjustment device comprises a first connecting rod 30 and a second connecting rod 30′. The first connecting rod 30 and the second connecting rod 30′ are each pivotably articulated relative to the backrest frame 12 about a second transverse axis A2. The first connecting rod 30 and the second connecting rod 30′ each comprise a first end and a second end. The first connecting rod 30 and the second connecting rod 30′ are each pivotably articulated to the backrest frame 12 at their first end. In particular, the first connecting rod 30 and the second connecting rod 30′ may each be pivotably articulated relative to a respective branch of a U-shaped guide 18 which is rigidly connected with the cross-member 17.

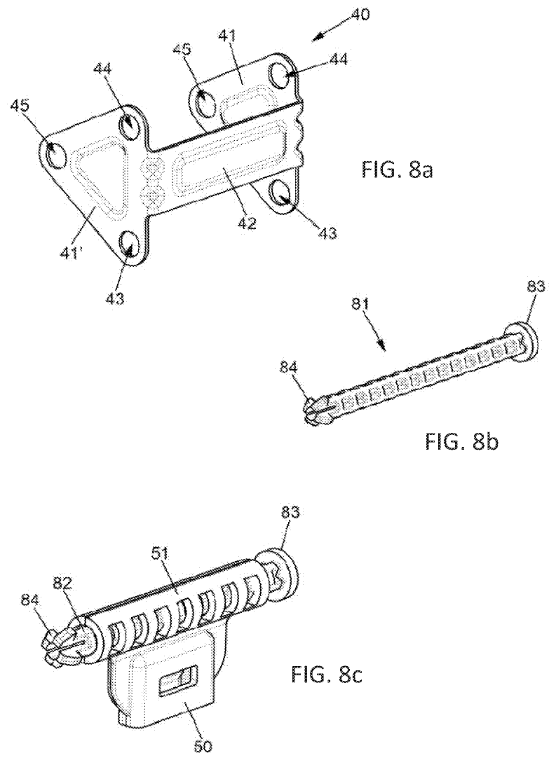

The upper backrest adjustment device comprises an intermediate part 40 between the support member 20 and each of the first connecting rod 30 and second connecting rod 30′. The intermediate part 40 comprises a first flange 41 and a second flange 41′ that are spaced apart from each other in the transverse direction Y. The first flange 41 and the second flange 41′ each extend perpendicularly to the transverse direction Y. The intermediate part 40 further comprises a side member 42 that extends transversely and that connects the first flange 41 and the second flange 41′ to each other. The side member 42 makes it possible to maintain the spacing in the transverse direction Y between the first flange 41 and the second flange 41′. More particularly visible in FIG. 8a, the first flange 41 and the second flange 41′ each comprise a first hole 43, a second hole 44 and a third hole 45 whose positioning and function are described in more detail below.

The intermediate part 40 is first pivotably articulated to the support member 20 about a third transverse axis A3. To this end, the upper backrest adjustment device comprises a first shaft 81 which extends along the third transverse axis A3. The first shaft 81 is rigidly connected to the support member 20 and the intermediate part 40 is pivotably mounted on the first shaft 81. To this end, the second hole 44 of the first flange 41 and the second flange 41′ are each centered on the third transverse axis A3 and the first shaft 81 extends through the second hole 44 of both the first flange 41 and the second flange 41′.

The support member 20 here comprises a first tab 23 and a second tab 23′ each extending from the rear face of the body 21. The first shaft 81 can extend transversely from the first leg 23 to the second leg 23′. The first tab 23 and the second tab 23′ can each comprise a hole centered on the third transverse axis A3, through which the first shaft extends 81. Particularly visible in FIG. 8b, the first shaft 81 may comprise a first retention part 83 relative to the support member 20 in a first direction of the third transverse axis A3 and a second retention part 84 relative to the support member 20 in a second direction of the third transverse axis A3, the second direction being opposite to the first direction. The first retention part 83 and the second retention part 84 may bear in the direction of the third transverse axis A3 respectively on a face of the first tab 23 and a face of the second tab 23′ that are opposite each other in the direction of the third transverse axis A3. The second retention part 84 can be resiliently deformable so as to be able to be inserted into the hole of each of the tabs 23, 23′ and the second hole 44 of each flange, and to cooperate by resilient return with the bearing face of the second tab 23′.

The intermediate part 40 is also pivotably articulated relative to the first connecting rod 30 and the second connecting rod 30′ about a fourth transverse axis A4. In particular, the first flange 41 is pivotably articulated relative to the first connecting rod 30 about the fourth transverse axis A4 and the second flange 41′ is pivotably articulated relative to the second connecting rod 30′ about the fourth transverse axis A4. The first connecting rod 30 and the second connecting rod 30′ are each respectively pivotably articulated relative to the first flange 41 and to the second flange 41′ at their second end. To this end, the first hole 43 of both the first flange 41 and the second flange 41′ is centered on the fourth transverse axis A4 and a pivot member extends through the first hole 43 of each flange. Advantageously, the arrangement of the two connecting rods 30, 30′ makes it possible to reinforce the structure of the upper backrest adjustment device in case of vehicle collision, in particular by making it possible to prevent the upper backrest adjustment device from twisting.

The upper backrest adjustment device finally comprises an actuator that makes it possible to adjust the position of the support member 20 about the first transverse axis A1 between a retracted position and an advanced position.

The actuator first comprises a connecting part 50 pivotably articulated relative to the intermediate part 40 about a fifth transverse axis A5. To this end, the upper backrest adjustment device comprises a second shaft 82 which extends along the fifth transverse axis A5. The second shaft 82 is rigidly connected to the intermediate part 40 and the connecting part 50 is pivotably mounted on the second shaft 82. The third hole 45 of each of the first flange 41 and the second flange 41′ is centered on the fifth transverse axis A5 and the second shaft 82 extends through the third of each of the first flange 41 and the second flange 41′. The connecting part 50 comprises a tubular part 51 whose axis is the fifth transverse axis A5 and through which the second shaft 82 extends free to rotate about the fifth transverse axis A5.

The second shaft 82 has a shape similar to the first shaft 81. Thus, as is particularly visible in FIG. 8c, the second shaft 82 comprises a first retention part 83 relative to the intermediate part 40 in a first direction of the fifth transverse axis A5 and a second retention part 84 relative to the support member 40 in a second direction of the third transverse axis A3, the second direction being opposite to the first direction. The first retention part 83 and the second retention part 84 may bear in the direction of the fifth transverse axis A5 respectively on a face of the first flange 41 and a face of the second flange 41′ that are opposite each other in the direction of the fifth transverse axis A5. The second retention part 84 of the second shaft 81 is resiliently deformable so as to be able to be inserted into the third hole of each flange 41, 41′, and to cooperate by resilient return with the bearing face of the second flange 41′.

In remarkable manner, the first flange 41 and the second flange 41′ are each substantially triangular in shape, the vertices of which are respectively in the vicinity of the third transverse axis A3, the fourth transverse axis A4 and the fifth transverse axis A5.

The actuator is also adapted to move the connecting part 50 in translation along a first axis Cl perpendicular to the transverse direction Y. The actuator herein comprises a motor 60 and a worm 70 extending along the first axis Cl perpendicular to the transverse direction Y. The connecting part 50 is integral, for example by embedding, of one end of the worm 70. The motor 60 is adapted to move the worm 70 in translation along the direction of the first axis Cl perpendicular to the transverse direction Y. For example, the motor 60 can move the worm 70 in translation along the first axis Cl perpendicular to the transverse axis by means of a gear.

As can be seen in FIGS. 6 and 7, the body 21 of the support member 20 forms, at the rear face, an indentation wherein the intermediate part 40 is partially received, the at least one first connecting rod 30 and the actuator regardless of the angular position of the support member 20 about the first axis. The upper backrest adjustment device thus advantageously has a small form factor.

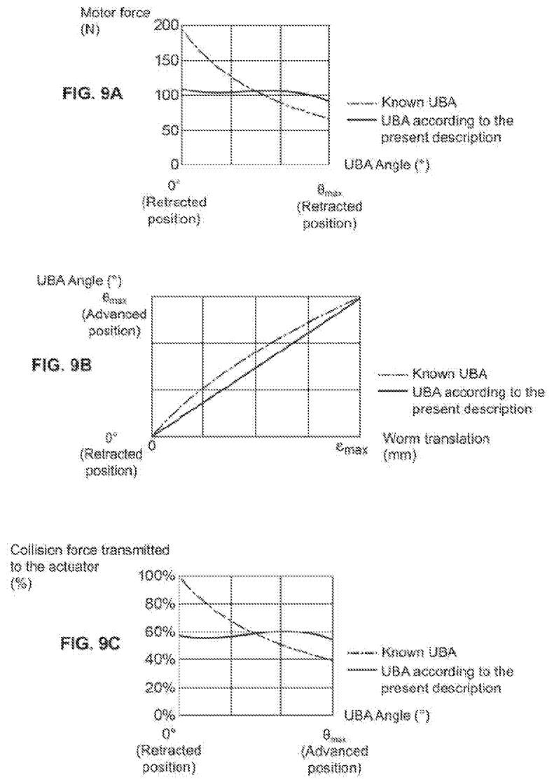

Reference is now made to FIG. 9a which represents a graph showing the variation of the force required by the actuator to pivot the support member 20 forward depending on the angular position of the support member 20 between the retracted position and the advanced position, for a comparative upper backrest adjustment device and according to the present description. The upper backrest adjustment device advantageously has a kinematic that reduces the variation in the force required by the actuator during the forward rotation of the support member 20 about the first transverse axis A1 between the retracted position and the advanced position. In particular, the observed maximum relative variation of the force required by the actuator to rotate the support member 20 about the first transverse axis A1 is less than 20%.

Furthermore, the kinematics of the upper backrest adjustment device allows a reduction in the force required by the actuator to drive the support member 20 forward about the first transverse axis A1 when the latter is in the vicinity of the retracted position relative to comparative upper backrest adjustment devices. Thus, the motor 60 may have reduced dimensions allowing it to be integrated into the backrest 11 while limiting, or even avoiding, the subjecting of the latter to excessive loading. This makes it possible to preserve the motor 60 from premature wear and to keep the upper backrest adjustment device compact.

Reference is now made to FIG. 9b, which represents a graph showing the variation of the angular position of the support member 20 between the retracted position and the advanced position as a function of the translational movement of the worm 70, for a comparative upper backrest adjustment device and according to the present description. It can be observed that, unlike the comparative device, the upper backrest adjustment device according to the present disclosure allows a linear relationship between the translation of the worm 70 along the direction of the first perpendicular axis Cl and the rotation of the support member 20 about the first transverse axis A1. The adjustment of the position of the support member 20 about the first transverse axis A1 is thus easier and more comfortable for an occupant seated on the seat 10.

Furthermore, the motor 60 and the worm 70 are pivotably articulated relative to the support member 20 about a sixth transverse axis A6. This reduces the isostatism stresses of the upper backrest adjustment device. Thus, the upper backrest adjustment device is advantageously isostatic, which facilitates assembly thereof and reduces, or eliminates, the risk of the worm 70 flexing in the event of a collision of the vehicle. The angular displacement about the sixth transverse axis A6 of the motor 60 and the worm 70 relative to the support member 20 may be less than or equal to 4°.

FIG. 9c represents a graph showing the variation of the force transmitted to the actuator in the event of a vehicle collision as a function of the angular position of the support member 20 between the retracted position and the advanced position, for a comparative upper backrest adjustment device of the prior art and one according to the present description. The graph of FIG. 9c corresponds in this instance to a rear collision to the vehicle of approximately 32 G. The kinematics of the upper backrest adjustment device according to the present description firstly makes it possible to reduce the maximum force transmitted to the kinematics and to the actuator during a collision (that is, when the support member 20 is in the retracted position). In particular, an approximately 40% reduction of the force transmitted to the kinematics and to the actuator during a collision was measured when the support member 20 is in the retracted position. The kinematics of the upper backrest adjustment device also make it possible to reduce the relative variation of the force transmitted to the actuator during a collision over the angular range of rotation of the support member 20 about the first transverse axis A1.

Notably in FIG. 4b, the second transverse axis A2, the fourth transverse axis A4 and the fifth transverse axis A5 may be substantially aligned when the support member 20 is in the advanced position or in the vicinity of the advanced position. Thus, when an occupant has their upper back resting on the body 21 of the support member 20, the force induced on the support member 20 is transmitted to the first connecting rod 30 and then to the backrest frame 12 instead of being transmitted to the actuator, which protects the actuator from premature wear.

The numerical designation (first, second, third, etc.) of the transverse axes results only from a drafting decision. Thus, the numerical designation of the transverse axes can be swapped in any order.

The present disclosure is not limited to the examples described above and is subject to numerous variants. Thus, according to one variant not shown, the connecting part 50 can be rigidly connected to a rod moved translationally along the first axis Cl perpendicular to the transverse direction by a hydraulic, pneumatic or electric cylinder, for example.

In order to improve the comfort of the occupant of a vehicle seat 10, in particular of a motor vehicle, the seat 10 can have several adjustments making it possible to be better suited to the morphology of the occupant. Thus, the position of the seat 10 can be adjusted relative to the steering wheel, depending on the height of the occupant. The seat backrest 11 can thus be more or less inclined relative to the squab of the seat. The seat can also be equipped with a headrest 15 whose height position, relative to the backrest 11 of the seat, can be adjusted by the occupant.

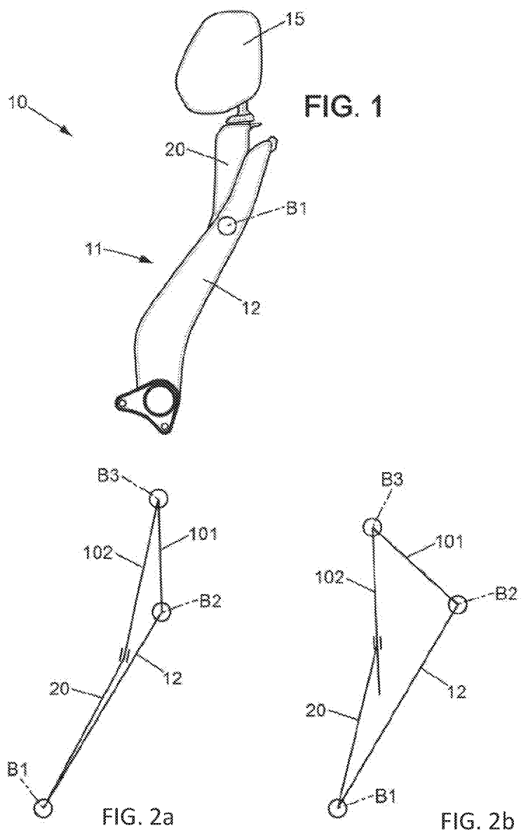

More recently, devices for adjusting the upper backrest 11 of a vehicle seat such as the position of the area supporting the occupant's upper back on the upper backrest 11 can be modified. To do this, the devices in question comprise a support member 20, pivoting relative to a backrest frame 12 about a first transverse axis B1 between the retracted position and an advanced position. In the retracted position, the support member 20 extends generally parallel to the backrest frame 12, while in the advanced position, the member is pivoted forward relative to the backrest frame 12 as seen in FIG. 1.

The support member 20 can be pivoted about the first transverse axis B1 manually. However, preferably, the upper backrest adjustment device comprises an actuator, to control the rotation of the support member 20 about the first transverse axis B1.

To do this, the actuator generally comprises a motor attached to the body of the support member 20 and which drives a pole 102 in translation in a substantially vertical direction, corresponding to the main direction of extension of the worm.

The upper backrest adjustment device comprises a connecting rod 101. The connecting rod 101 is pivotably articulated relative to the backrest frame 12 about a second transverse axis B2 and relative to the pole 102 about a transverse third axis B3.

The upper backrest adjustment device then operates as follows. The rotation of the motor causes the pole 102 to move upwards or downwards. The movement of the pole 102 then causes a rotation of the connecting rod 101 relative to the pole 102, about the transverse third axis B3, on the one hand, and/or relative to the backrest frame 12, about the transverse second axis B2, on the other hand. Finally, the rotation of the connecting rod 101 causes a rotation of the support member 20 relative to the backrest frame 12, about the first transverse axis B 1.

However, it has been observed that to rotate the support member 20 about the first axis B1 forward (that is from the retracted position to the advanced position), the motor must generate a much greater torque when the support member 20 is in the retracted position than when it is in the advanced position. In addition, the motor used must allow for its own integration into the backrest 11 of the seat 10, and to do so, must have reduced dimensions. However, reducing the dimensions of the motor generally entails reducing the torque that it can produce. Thus, the motors to drive the support member 20 whose dimensions are suitable for being arranged in the backrest 11 are generally overloaded when the support member 20 is in the retracted position, which may lead to premature wear of the electrical and mechanical components of the motor. Furthermore, the upper backrest adjustment device as described above has a degree of hyperstatism, which makes its assembly complex.

Thus, a collision can generate significant forces on the kinematics of the upper backrest adjustment device and in particular on the actuator, which can cause flexing of the worm of the actuator due to the degree of hyperstatism. It has also been found that during a rear collision, the forces transmitted to the kinematics and to the actuator are at their greatest when the support member 20 is in the retracted position.

A backrest for a vehicle seat is proposed, the backrest comprising a backrest frame and an upper backrest adjustment device, the upper backrest adjustment device comprising:
a support member comprising a body intended to receive, bearing against a front face, the upper back of an occupant of the seat, the support member being pivotably mounted about a first transverse axis on the backrest frame;
at least one first connecting rod pivotably articulated relative to the backrest frame about a second transverse axis;
an intermediate part between the support member and the first connecting rod, the intermediate part being pivotably articulated relative to the support member about a third transverse axis and relative to the first connecting rod about a fourth transverse axis,
an actuator for adjusting the position of the support member about the first transverse axis between a retracted position and an advanced position, the actuator comprising a connecting part pivotably articulated relative to the intermediate part about a fifth transverse axis, the actuator being adapted to move the connecting part in translation along a first axis perpendicular to the transverse direction.

Advantageously, the upper backrest adjustment device has a kinematic that reduces the variation in the force required by the actuator during the forward rotation of the support member about the first transverse axis between the retracted position and the advanced position (that is, from the retracted position to the advanced position). In particular, the observed maximum relative variation of the force required by the actuator to rotate the support member about the first transverse axis is less than 20%.

Furthermore, the kinematics of the upper backrest adjustment device allows a reduction in the force required by the actuator to drive the support member forward about the first transverse axis when the latter is in the vicinity of the retracted position relative to comparative upper backrest adjustment devices. Thus, the motor may have reduced dimensions allowing it to be integrated into the backrest while limiting, or even avoiding, the subjecting of the latter to excessive loading. This makes it possible to preserve the motor from premature wear and to keep the upper backrest adjustment device compact.

Also, the kinematics of the upper backrest adjustment device allows a reduction in the maximum force transmitted to the kinematics and to the actuator during a collision. In particular, an approximately 40% reduction of the force transmitted to the kinematics and to the actuator during a collision was measured when the support member is in the retracted position. The kinematics of the upper backrest adjustment device also make it possible to reduce the relative variation of the force transmitted to the actuator during a collision over the angular range of rotation of the support member about the first transverse axis.

The backrest frame may comprise a first upright and a second upright. The backrest frame may comprise at least one cross-member that extends transversely between the first upright and the second upright. The cross-member may be connected on each side in the transverse direction respectively to the first upright and to the second upright.

The body of the support member may be intended to be in contact, optionally by means of a lining and/or a cover at least partially covering the body of the support member, with the upper back of the occupant of the seat, in particular with the occupant's shoulders and/or shoulder blades. The body may have a front face, intended to be oriented toward the upper back of an occupant of the seat. The front face may be flat or concave. The body may also comprise a rear face opposite the front face. The rear face may comprise reinforcing ribs. The reinforcing ribs here form cavities. The rotation of the support member about the first transverse axis between a retracted position and an advanced position may correspond to a 15° rotation of the support member about the first transverse axis.

The support member and the uprights of the backrest frame may comprise associated reliefs, in particular by matching shapes, to guide the support member in rotation about the first transverse axis, relative to the first upright and second upright of the backrest frame. The reliefs of the support member can be transversely protruding from the body of the support member, the reliefs of the support member preferably extending from lateral faces of the body of the support member, the reliefs of the support member each being received respectively in a recess of the first upright and a recess of the second upright of the backrest frame.

The actuator may comprise a motor and a worm extending along the first axis perpendicular to the transverse direction, the connecting part being rigidly connected to one end of the worm, the motor being adapted to move the worm in translation along the direction of the first axis perpendicular to the transverse direction.

The upper backrest adjustment device comprising such an actuator allows a linearity between the translation of the worm in the direction of the first axis perpendicular to the transverse direction and the rotation of the support member about the first transverse axis. The adjustment of the position of the support member about the first transverse axis is thus easier and more comfortable for an occupant seated on the seat. The motor can move the worm in translation along the first axis perpendicular to the transverse axis by means of a gear.

The motor and the worm can be pivotably articulated relative to the support member about a sixth transverse axis. This reduces the isostatism stresses of the upper backrest adjustment device. Thus, the upper backrest adjustment device is advantageously isostatic, which facilitates assembly thereof and reduces, or eliminates, the risk of the worm flexing in the event of a collision of the vehicle. The angular displacement about the sixth transverse axis of the motor and the worm relative to the support member may be less than or equal to 4°.

The second transverse axis, the fourth transverse axis and the fifth transverse axis may be substantially aligned when the support member is in the advanced position or in the vicinity of the advanced position. Thus, when an occupant has their upper back resting on the body of the support member, the force induced on the support member is transmitted to the first connecting rod and then to the backrest frame instead of being transmitted to the actuator, which protects the actuator from premature wear.

The upper backrest adjustment device may comprise a second connecting rod pivotably articulated relative to the backrest frame about the second transverse axis. The intermediate part may comprise a first flange and a second flange separated from each other in the transverse direction, the first flange being pivotably articulated relative to the first connecting rod about the fourth transverse axis and the second flange being pivotably articulated to the second connecting rod about the fourth transverse axis. The arrangement of two connecting rods makes it possible to reinforce the structure of the upper backrest adjustment device in case of vehicle collision, in particular by making it possible to prevent the upper backrest adjustment device from twisting.

The intermediate part may comprise a side member that extends transversely and connects the first flange and the second flange together. The side member makes it possible to maintain the spacing in the transverse direction between the first flange and the second flange.

The first connecting rod and the second connecting rod may each comprise a first end and a second end. The first connecting rod and the second connecting rod may each be pivotably articulated to the backrest frame at their first end. In particular, the first connecting rod and the second connecting rod may each be pivotably articulated relative to a respective branch of a U-shaped guide which is rigidly connected with the cross-member.

The first connecting rod and the second connecting rod can each be respectively pivotably articulated relative to the first flange and to the second flange at their second end. To this end, the first flange and the second flange may each comprise a first hole centered on the fourth transverse axis and through which a pivot member extends.

The first flange and the second flange can each extend perpendicularly to the transverse direction, the first flange and the second flange each having a substantially triangular shape whose apices are respectively in the vicinity of the third transverse axis, the fourth transverse axis and the fifth transverse axis.

The upper backrest adjustment device may comprise a first shaft extending along the third transverse axis, the first shaft being rigidly connected to the support member, the intermediate part being pivotably mounted on the first shaft.

The first flange and the second flange can each comprise a second hole centered on the third transverse axis and through which the first shaft extends.

The support member may comprise a first tab and a second tab each extending from the rear face of the body. The first shaft can extend transversely from the first leg to the second leg. The first shaft may comprise a first retention part relative to the support member in a first direction of the third transverse axis and a second retention part relative to the support member in a second direction of the third transverse axis, the second direction being opposite to the first direction. The first retention part and the second retention part may bear in the direction of the third transverse axis respectively on a face of the first tab and a face of the second tab that are opposite each other in the direction of the third transverse axis.

The first tab and the second tab can each comprise a hole centered on the third transverse axis, through which the first shaft extends. The second retention part can be resiliently deformable so as to be able to be inserted into the hole of each of the tabs and the second hole of each flange, and to cooperate by resilient return with the bearing face of the second tab.

The upper backrest adjustment device may comprise a second shaft extending along the fifth transverse axis, the second shaft being rigidly connected to the intermediate part, the linking part being pivotably mounted on the second shaft.

The first flange and the second flange can each comprise a third hole centered on the fifth transverse axis and through which the second shaft extends.

The second shaft may comprise a first retention part relative to the intermediate part in a first direction of the fifth transverse axis and a second retention part relative to the intermediate member in a second direction of the third transverse axis, the second direction being opposite to the first direction. The first retention part and the second retention part may bear in the direction of the fifth transverse axis respectively on a face of the first flange and a face of the second flange that are opposite each other in the direction of the fifth transverse axis. The second retention part can be resiliently deformable so as to be able to be inserted into the third hole of each flange, and to cooperate by resilient return with the bearing face of the second flange.

The connecting part may comprise a tubular part through which the second shaft extends free to rotate about the fifth transverse axis.

The body of the support member can form, at a rear face, an indentation wherein the intermediate part is entirely or partially received, the at least one first connecting rod and the actuator. The upper backrest adjustment device advantageously has a small form factor.

According to another aspect, a vehicle seat is proposed comprising a squab with a squab frame, and a backrest as described above, the backrest frame being attached to the squab frame, the backrest frame being preferably pivotably mounted about a seventh transverse axis relative to the squab frame.

The vehicle seat may comprise a headrest. The body of the support member may be adapted to receive pins from the headrest, preferably so as to be able to adjust the height position relative to the support member.

The present disclosure relates to a backrest (11) for a vehicle seat (10) comprising a backrest frame and a upper backrest adjustment device comprising:
a support member (20) intended to receive, bearing against a front face, the upper back of an occupant of the seat, pivotably mounted on the backrest frame;
at least one first connecting rod (30) pivotably articulated relative to the backrest frame (11);
an intermediate part (40) between the support member (20) and the first connecting rod (30), pivotably articulated relative to the support member and relative to the first connecting rod (30),
an actuator for adjusting the position of the support member (20) between a retracted position and an advanced position, the actuator comprising a pivotably articulated connecting part (50) relative to the intermediate part (40).

1. A backrest for a vehicle seat, the backrest comprising a backrest frame and an upper backrest adjustment device, the upper backrest adjustment device comprising:
a support member comprising a body intended to receive, bearing against a front face, the upper back of an occupant of the seat, the support member being pivotably mounted about a first transverse axis on the backrest frame;
at least one first connecting rod pivotably articulated relative to the backrest frame about a second transverse axis;
an intermediate part between the support member and the first connecting rod, the intermediate part being pivotably articulated relative to the support member about a third transverse axis and relative to the first connecting rod about a fourth transverse axis,
an actuator for adjusting the position of the support member about the first transverse axis between a retracted position and an advanced position, the actuator comprising a connecting part pivotably articulated relative to the intermediate part about a fifth transverse axis, the actuator being adapted to move the connecting part in translation along a first axis perpendicular to the transverse direction.

2. The backrest of claim 1, wherein the actuator comprises a motor and a worm extending along the first axis perpendicular to the transverse direction, the connecting part being rigidly connected to one end of the worm, the motor being adapted to move the worm in translation along the direction of the first axis perpendicular to the transverse direction.

3. The backrest of claim 1, wherein the motor and the worm are pivotably articulated relative to the support member about a sixth transverse axis.

4. The backrest of claim 1, wherein the second transverse axis, the fourth transverse axis and the fifth transverse axis are substantially aligned when the support member is in the advanced position or in the vicinity of the advanced position.

5. The backrest of claim 1, wherein the upper backrest adjustment device comprises a second connecting rod pivotably articulated with respect to the backrest frame about the second transverse axis, and wherein the intermediate part comprises a first flange and a second flange separated from each other in the transverse direction, the first flange being pivotably articulated relative to the first connecting rod about the fourth transverse axis and the second flange being pivotably articulated to the second connecting rod about the fourth transverse axis.

6. The backrest of claim 5, wherein the first flange and the second flange each extend perpendicularly to the transverse direction, the first flange and the second flange each having a substantially triangular shape whose apices are respectively in the vicinity of the third transverse axis, the fourth transverse axis and the fifth transverse axis.

7. The backrest of claim 1, wherein the upper backrest adjustment device comprises a first shaft extending along the third transverse axis, the first shaft being rigidly connected to the support member, the intermediate part being pivotably mounted on the first shaft.

8. The backrest of claim 1, wherein the upper backrest adjustment device comprises a second shaft extending along the fifth transverse axis, the second shaft being rigidly connected to the intermediate part, the connecting part being pivotably mounted on the second shaft.

9. The backrest of claim 1, wherein the body of the support member forms at a rear face an indentation wherein the intermediate part is entirely or partially received, the at least one first connecting rod, and the actuator.

10. A vehicle seat comprising a squab with a squab frame, and the backrest according to claim 1, the backrest frame being attached to the squab frame, the backrest frame preferably being mounted pivotably mounted about a seventh transverse axis relative to the squab frame.
